(19) United States
(12) Patent Application Publication
(10) Pub. No.: US 2025/0139523 A1
(43) Pub. Date: May 1, 2025

(54) GENERATING DIVERSE DATASETS USING MACHINE-LEARNED LARGE LANGUAGE MODELS (LLMS) BASED ON VECTOR DISTANCE CONSTRAINTS

(71) Applicant: Maplebear Inc., San Francisco, CA (US)

(72) Inventors: Jacob Jensen, Metuchen, NJ (US); Guanghua Shu, Sunnyvale, CA (US)

(21) Appl. No.: 18/925,017

(22) Filed: Oct. 24, 2024

Related U.S. Application Data
(60) Provisional application No. 63/593,527, filed on Oct. 26, 2023.

(51) Int. Cl. G06N 20/00

(52) U.S. Cl. CPC G06N 20/00

(57) ABSTRACT

An online system augments a dataset in conjunction with a model serving system. The online system accesses a dataset for training a machine-learning model. The online system generates a prompt to generate candidate samples in the training dataset to the model serving system. The online system receives a response comprising one or more candidate samples. The online system compares the one or more candidate samples to at least one existing sample of the dataset to determine whether the one or more candidate samples are within a threshold level of similarity to an existing sample. If a candidate sample received from the machine-learning language model is not within the threshold level of similarity to an existing sample, the online system updates the dataset with the candidate sample.

### CROSS-REFERENCE TO RELATED APPLICATIONS

This application claims the benefit of U.S. Provisional Patent Application No. 63/593,527, filed on Oct. 26, 2023, which is incorporated herein by reference in its entirety.

### BACKGROUND

A training dataset includes a set of training samples for training a machine-learning model. An online system may be an online platform that connects users to services. As a user interacts with the online system, the online system may implement one or more machine-learning models to generate recommendations, predictions, or automate other processes within the online system. These models are trained on significantly large datasets, which are conventionally difficult to obtain. In some cases, synthetic samples are generated to augment the training dataset samples, so that the parameters of the machine-learning model can learn patterns in the synthetic samples in addition to the existing samples.

### SUMMARY

In accordance with one or more aspects of the disclosure, an online system augments a training dataset in conjunction with a model serving system. The online system accesses a dataset for training a machine-learning model to generate a response to a request. The dataset includes one or more existing samples for the response. The online system generates a prompt for input to a machine-learning language model. The prompt specifies at least the request, the dataset, and a request to generate candidate samples to be included in the dataset. The online system provides the prompt to the machine-learning language model with a temperature parameter value indicating a degree of randomness to be induced in the machine-learning language model.

The online system receives, from the model serving system, a response generated by executing the machine-learned language model on the prompt. The response comprises one or more candidate samples generated by the machine-learning language model. The online system compares the one or more candidate samples to at least one existing sample of the training dataset to determine whether the one or more candidate samples are within a threshold level of similarity to an existing sample. If a candidate sample received from the machine-learning language model is not within the threshold level of similarity to an existing sample, the online system updates the dataset with at least a subset of the candidate samples.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates mapping existing samples to embeddings in a latent space, in accordance with one or more embodiments.

FIG. 3B illustrates a process of generating a set of candidate samples by adjusting the temperature parameter value of a large language model (LLM), in accordance with one or more embodiments.

FIG. 3C illustrates mapping candidate samples to embeddings in the latent space, in accordance with one or more embodiments.

FIG. 4 is a flowchart for augmenting a training dataset based on existing samples of the training dataset, in accordance with some embodiments.

### DETAILED DESCRIPTION

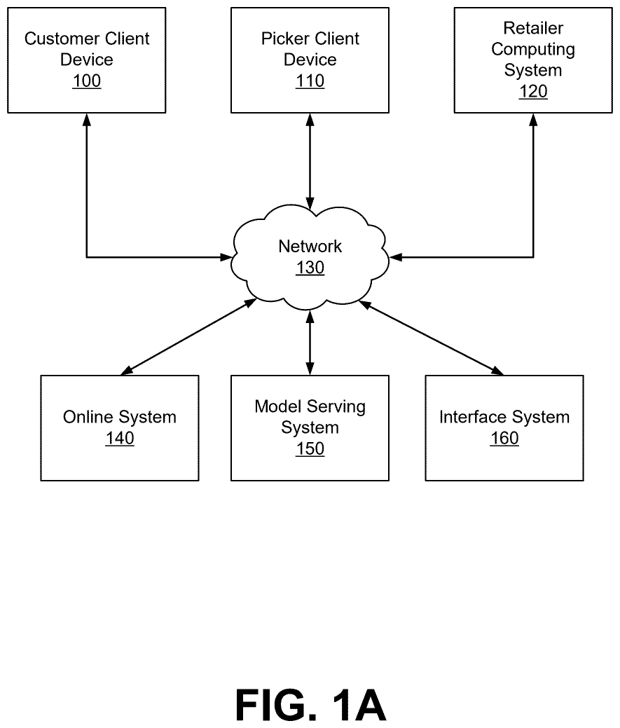

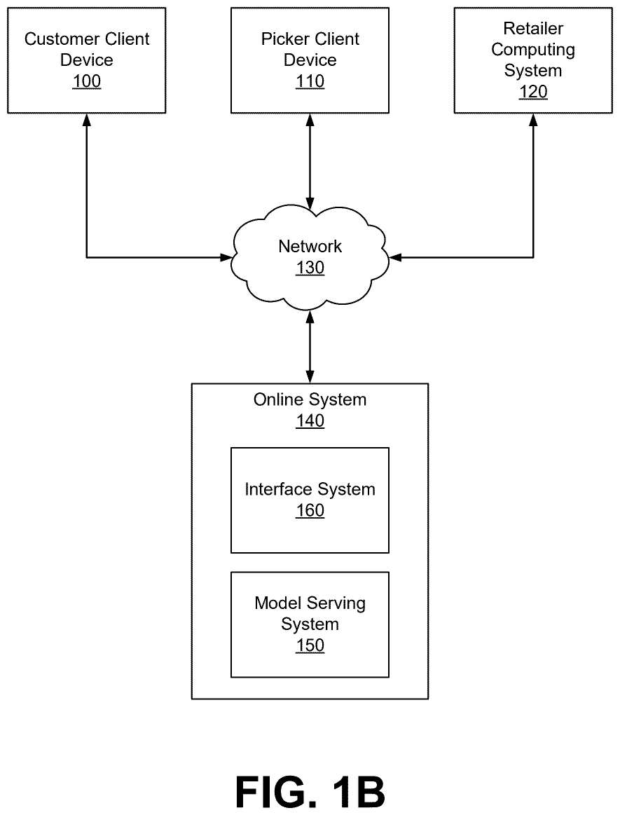

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

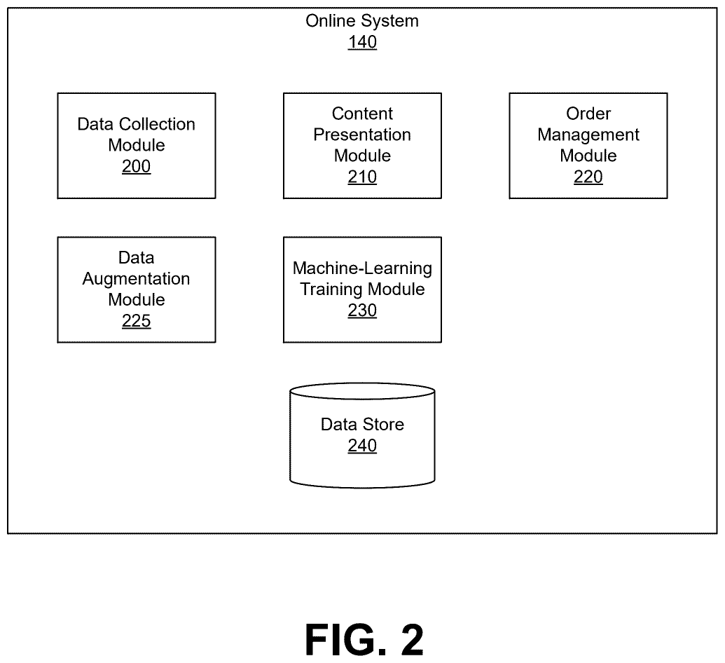

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, a diverse training dataset is important for the training of robust and reliable machine learning models. Diverse datasets encompass wider ranges of data points to effectively train machine learning models. However, developing such datasets can be computationally expensive, requiring substantial time and resources. The proposed method introduces a system for generating candidate samples to augment to an existing dataset, thereby improving the diversity among samples. The proposed method leverages a large language model (LLM) and a randomness parameter to generate the varied candidate samples. The proposed method includes a system for validating these candidate samples by comparing their similarity to existing samples in the dataset, ensuring that the candidate samples meaningfully enhance diversity.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Therefore, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a data augmentation module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

As an example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Therefore, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 tracks the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 tracks the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The online system 140 maintains and implements one or more machine-learning models to generate a variety of outputs including, but not limited to, recommendations for users and/or pickers, feedback and instructions for pickers, and predictions for users and pickers. Each model is trained on a robust training dataset of samples. The samples may be collected based on historical activities by users and pickers. In conventional systems, the samples are generated by collecting data from the historical activities, but this process is time consuming and inefficient, especially when a machine-learned model has a significant number of parameters that should be trained using a large number of training samples. For example, a machine-learned model may be configured to receive a food attribute and generate good wine pairing for the food. The samples for training are pairs of food and wine pairings that are estimated to be good pairings with each other. Moreover, in one or more embodiments, the online system 140 may use LLM's to generate samples for queries or action data. For example, returning to the food and wine pairing model, the online system 140 may use an LLM to generate example food and wine pairings that are likely good estimates because the LLM has been trained on real-world training data. However, LLMs often generate similar examples that lack diversity.

Accordingly, the data augmentation module 225 generates synthetic samples to augment an existing set of data like training datasets for training machine-learning models, and improve diversity among samples of the dataset. For example, the data augmentation module 225 may receive a request to augment a training dataset of suggested food and wine pairings with additional entries, referred to herein as candidate samples. The data augmentation module 225 constructs a prompt to be input to an LLM of the model serving system 150 and transmits the constructed prompt to the LLM. The prompt may include a request to augment the dataset (e.g., generate good food and wine pairing examples), existing entries in the training dataset, and/or a set of parameters for the LLM to generate the set of candidate samples. The existing entries in the dataset are encoded into embedded vector representations stored in a vector database. Although the techniques described below with reference to a request for additional food and wine pairings, the techniques may be applied to any request to update an existing dataset regardless of the content of the samples.

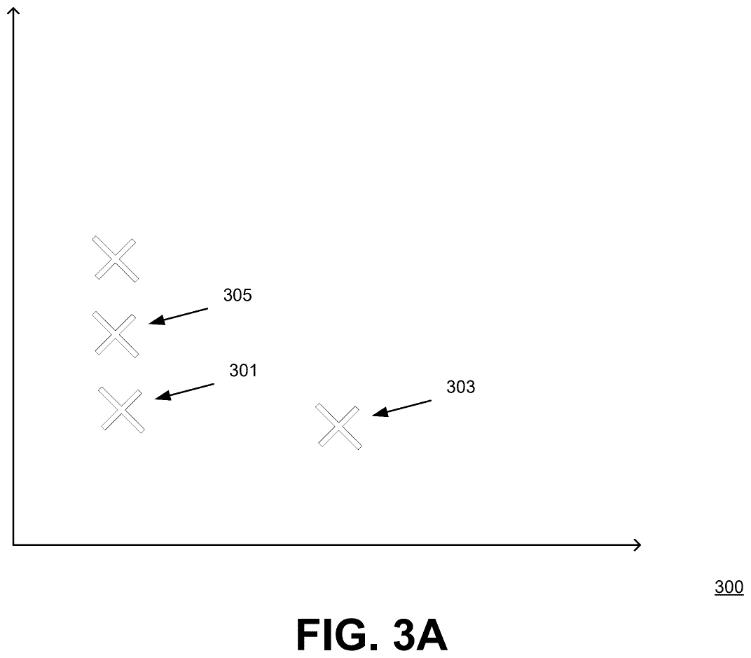

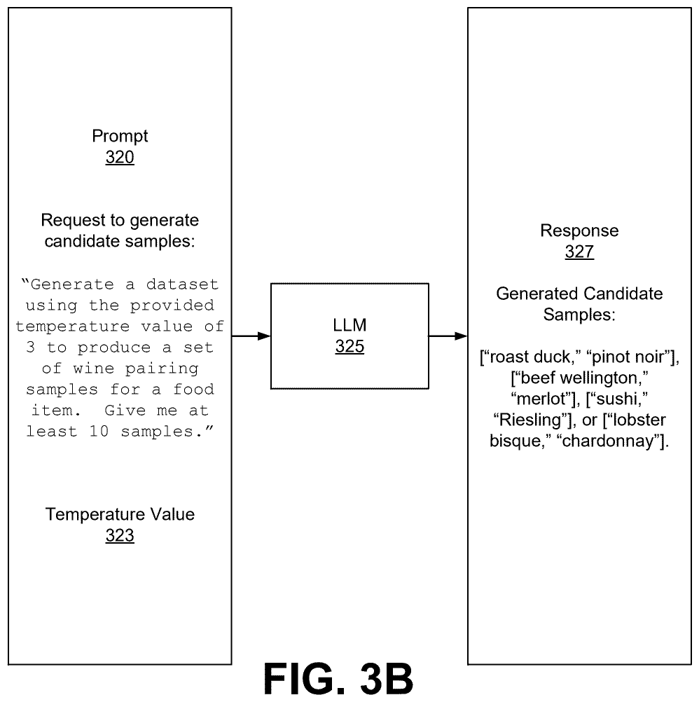

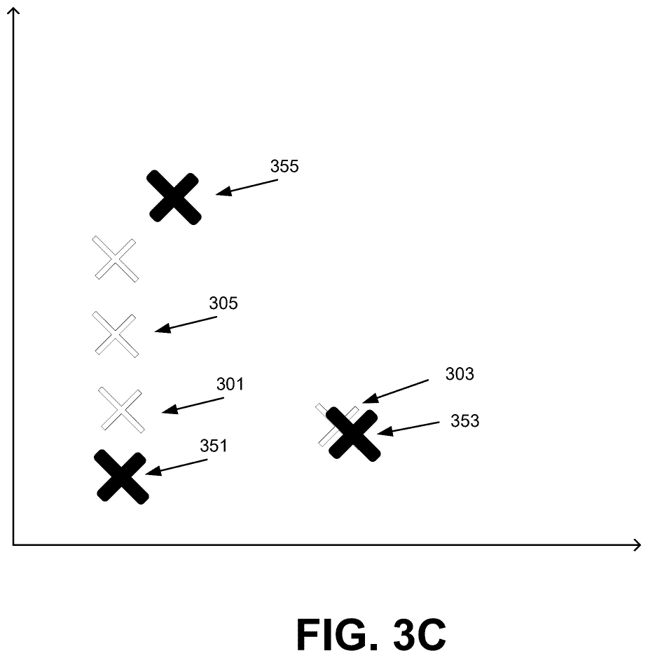

FIGS. 3A-3C illustrate an example process of generating a set of candidate samples and incorporating the candidate samples into a dataset, in accordance with one or more embodiments. In particular, FIGS. 3A-3C highlight an example process of generating a training dataset and comparing a candidate sample of an existing sample of the training dataset to determine whether the one or more candidate samples are within a threshold level of similarity.

In one or more embodiments, the data augmentation module 225 accesses a training dataset for training a machine learning model. The data augmentation module 225 utilizes one or more existing samples from the training dataset. The training dataset may include samples representing pairs of wine with specific target food items. For example, a sample in the dataset might be the pair [“beef wellington,” “cabernet sauvignon”].

In the example of FIG. 3A, the data augmentation module 225 applies a machine learning embedding model to the content of the existing samples from the training dataset. As shown in FIG. 3A, a latent space 300 for a plurality of generated embeddings is illustrated, in accordance with one or more embodiments. Each “X” represents an embedding for an existing sample within the training dataset. As an example, “X” 303 represents the example sample of [“beef wellington,” “cabernet sauvignon”]. For the sake of illustration there is a subset of samples in display, but in other embodiments, it is appreciated that there may be any number of samples within the training dataset in FIG. 3A.

In one or more embodiments, the LLM generates one or more candidate samples by adjusting (e.g., increasing) a temperature parameter that is associated with a degree of randomness to generate more diverse candidate samples compared to when the temperature parameter is zero or a small number. The data augmentation module 225 generates a prompt 320, requesting the generation of candidate samples for the training dataset, along with a temperature parameter value 323. As an example, a prompt to the LLM 325 may be:

“Generate a dataset using the provided temperature value of 3 to
produce a set of wine pairing samples for a food item. Give me
at least 10 samples.”

The data augmentation module 225 receives a response 327, which includes a set of generated candidate samples. For example, the data augmentation module 225 receives a set of pairs of wine and a respective food item, such as the candidate pair [“roast duck,” “pinot noir”], [“beef wellington,” “merlot”], [“sushi,” “Riesling”], or [“lobster bisque,” “chardonnay”].

In one or more embodiments, the LLM generates candidate samples by accessing an LLM dictionary of sub-words. In one or more embodiments, the data augmentation module 225 includes a prefix in the prompt, which provides a basis for the LLM to generate candidate samples from the dictionary of sub-words or words. For each sub-word in the LLM library, also referred to herein as “tokens,” the LLM generates a score describing a likelihood that the sub-word word will follow the prefix. For example, if the first token representing the first prefix is “beef,” the LLM will generate a higher score for the sub-word “wellington” than it would for the sub-word “fish” because “beef wellington” is an actual term for a food item and “beef fish” is not.

Additionally, the data augmentation module 225 may provide a temperature parameter in the prompt describing a measure of randomness for the LLM to apply when selecting candidate samples. Specifically, in one instance, an LLM generates the output via one or more autoregressive iterations, where at each iteration, the next token for that iteration is generated. A token may be a numerical embedding that encodes a word, a phrase, a sub-word (e.g., 4-character units), and the like. At a given iteration, the next token for the output sequence is generated by offering a probability of likelihood to each token in the dictionary, and selecting the token that satisfies a criterion (e.g., token with highest likelihood). In one instance, the temperature is given by T in the following equation:

$${P}_{i} = \frac{{e}^{\frac{{y}_{i}}{T}}}{{\sum }_{k = 1}^{n} {e}^{\frac{{y}_{k}}{T}}}$$

where yᵢ is the output from the last layer of the LLM model for token i, yₖ is the output from the last layer of the LLM model for each of token k=1, 2, . . . , n in a dictionary of token and sub-word (or word) mappings for n sub-words (or words), and Pᵢ denotes the logit probability for the token i.

If the data augmentation module 225 specifies a low temperature measurement (e.g., zero), the LLM may generate a population of candidate samples by selecting the token with the highest prediction likelihood at each iteration. Alternatively, if the data augmentation module 225 specifies a high temperature measurement, the LLM may pick any token from the population with a score above a threshold score, resulting in a highly random candidate sample.

Accordingly, the data augmentation module 225 may adjust the temperature parameter so that the LLM induces a degree of randomness when generating candidate samples to increase diversity while meeting validation constraints. In one or more embodiments, at a given iteration, a higher temperature allows the LLM to select one or more tokens for the next position that satisfy a threshold criterion dependent on the temperature value. For example, the threshold criterion for a temperature value of 0.1 may indicate that any token within the top 20 tokens with highest likelihoods can be selected. In one or more embodiments, the data augmentation module 225 receives a temperature parameter from a human operator. In other embodiments, the data augmentation module 225 generates a temperature parameter using a machine-learning model trained based on historical temperature parameters.

Returning to the above example with the prefix “beef,” if the data augmentation module 225 specifies a minimum temperature measurement, the LLM may offer the sub-word “stew” the highest score and only select “beef stew” as a candidate sample. However, if the data augmentation module 225 specifies a higher temperature measurement, the LLM may determine the sub-words “stew,” “wellington,” and “broccoli” satisfy the threshold score and/or select “beef stew,” “beef wellington,” and “beef and broccoli” for the food items in each of the candidate samples.

In FIG. 3C, the data augmentation module 225 applies a machine learning embedding model to the content of the generated candidate samples of the training dataset. As shown in FIG. 3C, the latent space includes the plurality of sample embeddings and candidate embeddings, in accordance with one or more embodiments. The bolded “X” represents the generated candidate samples of the training dataset. As an example, the bolded “X” 351 represents an embedding for the generated candidate sample of [“sushi,” “Riesling”].

The data augmentation module 225 compares the embedding of each candidate sample generated using the LLM to embeddings of existing samples in the dataset. The data augmentation module 225 compares the embedding of each candidate sample to embeddings of the existing training dataset and determines whether the candidate sample is within a threshold level of similarity to a sample already in the existing training dataset. If the candidate sample is within the threshold level of similarity (e.g., the candidate sample is too similar to an existing sample), the data augmentation module 225 rejects the candidate sample to reduce redundant examples.

In the example shown in FIG. 3C, the data augmentation module 225 compares the embeddings for the generated candidate sample of the datasets with embeddings of one or more existing samples to determine whether the one or more candidate samples are within a threshold level of similarity with the one or more existing samples. As an example, “X” 303 represents the accessed example sample of [“beef wellington,” “cabernet sauvignon”]. The bolded “X” 353 represents the candidate sample of [“beef wellington,” “merlot”]. The data augmentation module 225 determines that the generated candidate sample is within the threshold level of similarity. This is because both pairs represent beef wellington and a dark red wine, and the embeddings indicate that both samples are very similar to each other semantically. As a response, the data augmentation module 225 removes the generated candidate sample from adding to the dataset. The data augmentation module 225 adds the remaining candidate samples to the dataset.

For datasets with a number of samples below a given threshold, referred to herein as “small scale datasets,” the LLM may compare the embedding of a candidate sample to the embedding of each existing sample of the training dataset. In one or more embodiments, the LLM performs the comparison by determining a cosine dot product of the embedding of the candidate sample and the embedding of the existing sample. The data augmentation module 225 may receive the threshold separating small scale datasets from large scale datasets from a human operator or determine the threshold using a machine-learning model.

For training datasets with a number of samples above the given threshold, referred to herein as “large scale datasets,” the data augmentation module 225 may perform a nearest neighbor search on embeddings of existing samples. The data augmentation module 225 compares the embedding of the candidate sample to the embeddings of one or more of the nearest neighbors identified from the existing samples. In one or more embodiments, the LLM performs the comparison by determining the cosine dot product of the embedding of the candidate sample and the embedding of the nearest neighbor of the existing samples. In another embodiment, the LLM determines an aggregate embedding for multiple of the nearest neighbors of the existing samples and determines the cosine dot product of the embedding of the candidate sample and the aggregate embedding. In yet another embodiment, the data augmentation module 225 determines the cosine dot product of the embedding of the candidate sample and the embedding of each of a group of nearest neighbors and aggregates (e.g., averages) the cosine dot products determined for each nearest neighbor.

In either the small scale dataset or the large scale dataset, the data augmentation module 225 rejects a candidate sample if it determines that the candidate sample and an existing sample are within a threshold level of similarity based on its comparison. The data augmentation module 225 may receive the threshold level of similarity from a human operator or determine the threshold using a machine-learning model. In one or more embodiments, the data augmentation module 225 also rejects a candidate sample if it determines that the candidate sample and an existing example are above a threshold level difference. If above a threshold difference, this may mean that the candidate sample is not really relevant to the request in the prompt.

The LLM communicates the candidate sample to the data augmentation module 225 if it determines that the candidate sample and no existing sample are within a threshold level of similarity. Upon receipt of a candidate sample from the LLM, the data augmentation module 225 augments the training dataset with the candidate sample.

The online system 140 may implement the techniques described above to generate predictive responses to user queries. For example, the data augmentation module 225 may receive a user query with a request for wine pairings for beef wellington. The data augmentation module 225 may apply the techniques described above to generate candidate samples of beef wellington and wine pairings to be offered to the user by specifying a temperature value that will induce randomness.

In one or more embodiments, a user may submit a query requesting recommendations or suggestions of items. The data augmentation module 225 transmits the request to the LLM, which generates a set of suggested items using the techniques described above with regards to the LLM library. The data augmentation module 225 may also apply the techniques described above to remove redundant suggested items (e.g., suggested items within a threshold level of similarity to each other) and return the list of suggested items to the data augmentation module 225. For example, a user may submit a query requesting wine pairings for beef. The LLM may generate a suggested set of wines that pair well with beef-based dishes and remove any wines that are within a threshold level of similarity to an already suggested beef and wine pairing.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example. In one or more embodiments, the machine learning training module 230 trains a machine learning model, and receives the dataset synthesized by the data augmentation module 225 that includes a set of existing samples but also a set of augmented samples that were added via the process described herein with respect to FIGS. 3A-3B. This way, machine learning models can be trained using a larger number of samples that will increase the accuracy of the model performance.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

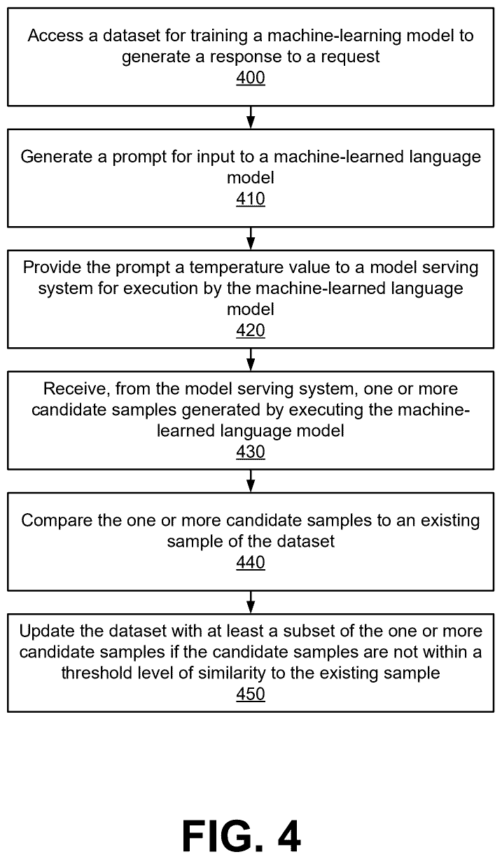

FIG. 4 is a flowchart for augmenting a training dataset based on existing samples of the training dataset, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system accesses 400 a dataset for training a machine-learning model to generate a response to a request. The dataset includes one or more existing samples for the response. The online system generates 410 a prompt for input to a machine-learning language model. The prompt specifies at least the request, the dataset, and a request to generate candidate samples to be included in the dataset. The online system provides 420 the prompt and a temperature parameter value to the model serving system for execution by the machine-learning language model. The temperature parameter value indicates a degree of randomness to be induced in the machine-learning language model. To generate the response, the model serving system 150 identifies a set of candidate samples using an LLM dictionary and removes redundant candidate samples by comparing an embedding of each candidate sample to embeddings of existing samples of the dataset. The online system receives 430, from the model serving system 150, the response generated by executing the machine-learned language model on the prompt. The response includes one or more candidate samples generated by the machine-learning language model. The online system compares 440 the one or more candidate samples to at least one existing sample of the training dataset to determine whether the one or more candidate samples are within a threshold level of similarity to at least one existing sample. The online system updates 450 the dataset with at least a subset of the candidate samples received from the model serving system if it determines the subset of candidate samples are not within the threshold level of similarity to the existing samples of the dataset.

In one or more embodiments, the method further includes training a machine-learning model with the augmented training dataset. Since the augmented dataset has a more diverse data distribution by leveraging the temperature parameter and the general knowledge encoded in the parameters of an LLM, the increased sample size can be used to train the parameters of the machine-learning model to improve the accuracy of the machine-learning model in a way that is different from existing training methods. For example, the example food and wine pairing samples can be used to train a machine-learning model that generates a wine that users are predicted to purchase given a food item, so that recommendations for wine can be presented to users of orders. The machine-learning model can be trained on the augmented data, applied real-time to a user with food items in an order to generate recommendations for the user. Since the model was trained with augmented training data, the model is able to incorporate a wider knowledge base obtained from the LLM that also results in higher accuracy.

### ADDITIONAL CONSIDERATIONS

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
accessing a dataset for training a machine-learning model, the dataset comprising one or more existing samples;
generating a prompt for input to a machine-learning language model, the prompt specifying at least a description of the dataset and a request to generate candidate samples to be included in the dataset;
providing the prompt for execution by the machine-learning language model and a temperature parameter value indicating a degree of randomness to be induced in the machine-learning language model;
receiving a response generated by executing the machine-learned language model on the prompt, the response comprising one or more candidate samples generated by the machine-learning language model;
comparing the one or more candidate samples to at least one existing sample of the dataset to identify whether the one or more candidate samples are within a threshold level of similarity to the at least one existing sample; and
updating the dataset with at least a subset of the candidate samples responsive to identifying that the similarity of the subset of the candidate samples are not within the threshold level of similarity.

2. The method of claim 1, wherein the method further comprises:
generating embeddings for the at least one existing sample by applying a machine-learning embedding model to the at least one existing sample; and
generating embeddings for the one or more candidate samples by applying the machine-learning embedding model to the one or more candidate samples.

3. The method of claim 1, wherein responsive to identifying at least one candidate sample is within the threshold level of similarity, the method further comprising:
removing the at least one candidate sample from the one or more candidate samples to create the subset of candidate samples.

4. The method of claim 3, wherein comparing the one or more candidate sample comprises:
comparing an embedding for the at least one candidate sample to an embedding for each existing sample in the dataset; and
removing the at least one candidate sample responsive to identifying that a distance between the embedding for the at least one candidate sample and the embedding for the at least one existing sample is below the threshold level of similarity.

5. The method of claim 3, wherein comparing the one or more candidate samples further comprises:
identifying a nearest neighbor sample to the at least one candidate sample that is associated with an embedding closest in distance to the embedding for the at least one candidate sample; and
removing the at least one candidate sample responsive to identifying that a distance between the embedding for the at least one candidate sample and the embedding for the nearest neighbor sample is below the threshold level of similarity.

6. The method of claim 1, further comprising:
applying parameters of the machine-learning model to the updated dataset to generate estimated outputs;
computing a loss function based on the estimated outputs; and
updating the parameters of the machine-learning model to reduce the loss function.

7. The method of claim 6, further comprising:
applying the machine-learning model trained based on the updated dataset to generate one or more recommendations; and
transmitting instructions to a client device to cause presentation of the one or more recommendations to a user of the client device.

8. The method of claim 1, wherein the temperature parameter value T is given by the following equation:
$${P}_{i} = \frac{{e}^{\frac{{y}_{i}}{T}}}{{\sum }_{k = 1}^{n} {e}^{\frac{{y}_{k}}{T}}}$$
where yᵢ is an output from a last layer of the machine-learning language model for token i, yₖ is the output from the last layer of the machine-learning language model for each of token k=1, 2, . . . , n in a dictionary of token and word mappings for n words, and wherein Pᵢ denotes a logit probability for the token i.

9. The method of claim 3, wherein comparing the one or more candidate samples further comprises:
performing a dot product between the embedding for the at least one candidate sample and the embedding of at least one existing sample.

10. A non-transitory computer-readable storage medium storing computer instructions, when executed by one or more processors, cause the one or more processors to:
access a dataset for training a machine-learning model, the dataset comprising one or more existing samples;
generate a prompt for input to a machine-learning language model, the prompt specifying at least a description of the dataset and a request to generate candidate samples to be included in the dataset;
provide the prompt for execution by the machine-learning language model and a temperature parameter value indicating a degree of randomness to be induced in the machine-learning language model;
receive a response generated by executing the machine-learned language model on the prompt, the response comprising one or more candidate samples generated by the machine-learning language model;
compare the one or more candidate samples to at least one existing sample of the dataset to identify whether the one or more candidate samples are within a threshold level of similarity to the at least one existing sample; and
update the dataset with at least a subset of the candidate samples responsive to identifying that the similarity of the subset of the candidate samples are not within the threshold level of similarity.

11. The non-transitory computer-readable storage medium of claim 10, wherein the computer instructions further cause the one or more processors to:
generate embeddings for the at least one existing sample by applying a machine-learning embedding model to the at least one existing sample; and
generate embeddings for the one or more candidate samples by applying the machine-learning embedding model to the one or more candidate samples.

12. The non-transitory computer-readable storage medium of claim 10, wherein responsive to identifying at least one candidate sample is within the threshold level of similarity, the computer instructions further cause the one or more processors to:
remove at least one candidate sample from the one or more candidate samples to create the subset of candidate samples.

13. The non-transitory computer-readable storage medium of claim 12, wherein the computer instructions for comparing the one or more candidate sample further cause the one or more processors to:
compare an embedding for the at least one candidate sample to an embedding for each existing sample in the dataset; and
remove the at least one candidate sample responsive to identifying that a distance between the embedding for the at least one candidate sample and the embedding for the at least one existing sample is below the threshold level of similarity.

14. The non-transitory computer-readable storage medium of claim 12, wherein the computer instructions for comparing the one or more candidate samples further cause the one or more processors to:
identify a nearest neighbor sample to the at least one candidate sample that is associated with an embedding that is closest in distance to the embedding for the at least one candidate sample; and
remove the at least one candidate sample responsive to identifying that a distance between the embedding for the at least one candidate sample and the embedding for the nearest neighbor sample is below the threshold level of similarity.

15. The non-transitory computer-readable storage medium of claim 12, wherein the computer instructions further cause the one or more processors to:
apply parameters of the machine-learning model to the updated dataset to generate estimated outputs;
compute a loss function based on the estimated outputs; and
update the parameters of the machine-learning model to reduce the loss function.

16. A computer system, comprising:
one or more processors:
a non-transitory computer-readable storage medium storing computer instructions, when executed by the one or more processors, cause the one or more processors to:
access a dataset for training a machine-learning model, the dataset comprising one or more existing samples;
generate a prompt for input to a machine-learning language model, the prompt specifying at least a description of the dataset and a request to generate candidate samples to be included in the dataset;
provide the prompt to a model serving system for execution by the machine-learning language model and a temperature parameter value indicating a degree of randomness to be induced in the machine-learning language model;
receive, from the model serving system, a response generated by executing the machine-learned language model on the prompt, the response comprising one or more candidate samples generated by the machine-learning language model;
compare the one or more candidate samples to at least one existing sample of the dataset to determine whether the one or more candidate samples are within a threshold level of similarity to the at least one existing sample; and
update the dataset with at least a subset of the candidate samples responsive to determining that the similarity of the subset of the candidate samples are not within the threshold level of similarity.

17. The computer system of claim 16, wherein the computer instructions further cause the one or more processors to:
generate embeddings for the at least one existing sample by applying a machine-learning embedding model to the at least one existing sample; and
generate embeddings for the one or more candidate samples by applying the machine-learning embedding model to the one or more candidate samples.

18. The computer system of claim 16, wherein responsive to identifying at least one candidate sample is within the threshold level of similarity, the computer instructions further cause the one or more processors to:
remove at least one candidate sample from the one or more candidate samples to create the subset of candidate samples.

19. The computer system of claim 18, wherein the computer instructions for comparing the one or more candidate sample cause the one or more processors to:
compare an embedding for the at least one candidate sample to an embedding for each existing sample in the dataset; and
remove the at least one candidate sample responsive to determining that a distance between the embedding for the at least one candidate sample and the embedding for the at least one existing sample is below the threshold level of similarity.

20. The computer system of claim 18, wherein the computer instructions for comparing the one or more candidate samples further cause the one or more processors to:
identify a nearest neighbor sample to the at least one candidate sample that is associated with an embedding that is closest in distance to the embedding for the at least one candidate sample; and
remove the at least one candidate sample responsive to determining that a distance between the embedding for the at least one candidate sample and the embedding for the nearest neighbor sample is below the threshold level of similarity.
